(19) United States
(12) Patent Application Publication
(10) Pub. No.: US 2014/0058679 A1
(43) Pub. Date: Feb. 27, 2014

(54) Wake Status Detection for Suppression and Initiation of Notifications

(71) Applicants: Devrim Varoglu, Santa Clara, CA (US); Swapnil Dave, Santa Clara, CA (US)

(72) Inventors: Devrim Varoglu, Santa Clara, CA (US); Swapnil Dave, Santa Clara, CA (US)

(73) Assignee: APPLE INC., Cupertino, CA (US)

(21) Appl. No.: 13/592,928

(22) Filed: Aug. 23, 2012

(51) Int. Cl. G06F 19/00; G06F 9/54

(52) U.S. Cl. 702/19; 719/318; 719/315

(57) ABSTRACT

Parameters of an electronic device may be evaluated in order to determine a probability of a particular wake status of a user of the device. The determined probabilities of a certain wake status based on the evaluated parameters may be combined to identify a combined wake status of the user. The identified wake status may be utilized to implement certain device functionality. The wake status can enable a user to suppress notifications during a particular wake status or to perform an action (such as generating a reminder) according to a particular wake status.

### BACKGROUND

This disclosure relates generally to an identification of a device user's sleep state. More particularly, but not by way of limitation, it relates to a utilization of a knowledge of the user's sleep state to enable certain device functionality.

Devices such as mobile phones, personal music players, tablet computers, and other similar devices have become an integral part of many users' lives. Users may utilize such devices to send and receive telephone calls, electronic mail messages, and social network messages, to browse the Internet, to get directions, to configure reminders for themselves, to check news and weather reports, and to perform many other everyday functions. Many of these functions may result in notifications being presented to a user. For example, received communications (e.g., emails, phone calls, etc.) may result in the device generating an audible tone or otherwise notifying the user of the incoming communication. Similarly, a user may configure a reminder or alarm such that the device generates a notification at some time in the future.

It is often desirable that device notifications be keyed to a sleep pattern of the user. For example, a use may not want to receive notifications during the period that the user is sleeping and may instead prefer to review any notification-generating events when the user wakes up. In a similar manner, a user may wish to configure a reminder that is triggered based upon the user's sleep pattern. For example, a user may want to be reminded of a doctor's appointment when the user wakes up on the morning of the appointment.

A user may manually disable alarm notifications during the period of time that the user is normally asleep or may configure a reminder such that it generates a notification at the typical tune the user wakes up. Unfortunately, these approximated times may not correspond with the user's actual sleep state. For example, a user may create a reminder that causes a notification to be generated at the user's typical wake up time of 8:00 am. However, the user may be awakened by the notification when they would prefer to sleep in and receive the notification when they wake up on theft own. Likewise, a user may disable notifications during the user's typical weekday sleeping time of 10:00 pm to 6:00 am, but the user may be awakened by a notification received at 6:00 am on the weekend when the user would prefer that the alerts be disabled during the user's actual sleeping time. It would therefore be desirable to allow notifications to be keyed to a user's actual wake status.

### SUMMARY

In one embodiment, a method to identify an occurrence of an event on a device where the event has an associated notification is described. The wake status of a user of the device may be automatically determined based on one or more measured device parameter values. The notification of the event may be suppressed if the wake status is a first value and allowed if the wake status is a second value. The method may be embodied in program code and stored on a non-transitory storage medium. The stored program code may be executed by a processor that is part of, or controls, the device.

In another embodiment a method to receive a request to perform an action on a device having a trigger condition based on a wake status of a user of the device is described. The wake status of the user may be determined automatically according to the evaluation of one or more parameters of the device, and the user's wake status may be monitored. The requested action may be performed when the wake status matches the trigger condition. The method may be embodied in program code and stored on a non-transitory storage medium. The stored program code may be executed by a processor that is part of, or controls, the device.

In still another embodiment, a device having a memory, a display, and a processor coupled to the memory and the display is described. The processor may execute program code stored in the memory to identify an occurrence of an event on the device having an associated notification. It may then be determined whether the notification is dependent upon a wake status of the user of the device, and, if so, the wake status may be determined. The notification of the event may be suppressed if the wake status is a first value and allowed if the wake status is a second value or the notification is not dependent upon the wake status.

### BRIEF DESCRIPTION OF THE DRAWINGS

FIG. 1 is a flowchart that illustrates an operation to determine a wake status of a user of an electronic device in accordance with one embodiment.

FIG. 2 is a flowchart that illustrates an operation to suppress or allow a notification on an electronic device based on a wake status of the user of the device in accordance with one embodiment.

FIG. 3 is a flowchart that illustrates an operation to perform an action on an electronic device that is triggered based on a wake status of a user of the device in accordance with one embodiment.

FIG. 4 illustrates an example user interface of an electronic device on which an alert suppression operation may be enabled in accordance with one embodiment.

FIG. 5 illustrates an example user interface of an electronic device on which a wake status-triggered action operation may be enabled in accordance with one embodiment.

FIG. 6 is a block diagram of an illustrative electronic device in accordance with one embodiment.

### DETAILED DESCRIPTION

This disclosure pertains to systems, methods, and computer readable media for determining a wake status of a user of an electronic device. In general, techniques are disclosed for automatically determining a wake status of a device's user based on measured device parameter values and using this wake status as a trigger for the performance of an action or to suppress alerts in accordance with the user's desires.

In the following description, for purposes of explanation, numerous specific details are set forth in order to provide a thorough understanding of the inventive concept. As part of this description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development efforts might be complex and time-consuming, but would nevertheless be a routine undertaking for those of ordinary skill in the art of electronic device operations having the benefit of this disclosure.

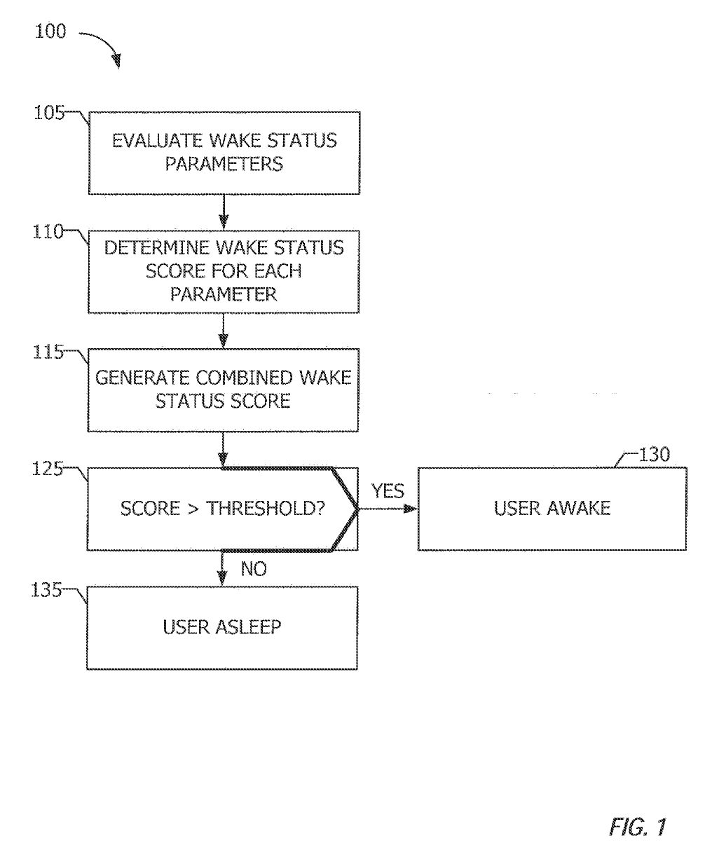

Referring to FIG. 1, wake status determination operation 100 evaluates parameters of an electronic device to determine the wake status of the device's user (block 105). As used herein, the phrase “wake status” refers to the general state of consciousness during which a particular usage of a device is desired by the device's user. Therefore, although a user may be awakened during the middle of the night, because the user's intended usage of the device during that time period may correspond to the “asleep” wake status usage, the appropriate wake status may be determined to be “asleep.” Accordingly, the description of a user as either “awake” or “asleep” is not intended to indicate the strict state of consciousness of the user, but rather to indicate the general state of consciousness of the user during which a particular device usage may apply.

A number of different device parameters may be utilized to determine the wake status of a device's user. In one embodiment, a parameter indicating whether the device is connected to a battery charger may provide an indication of a wake status of the device's user. It is common for a user of an electronic device (such as a mobile phone, personal music player, or tablet computer device) to charge the device's battery while the user sleeps. Accordingly, the connection of the device to a battery charger during, or independent from, a specified time may be an indication that the device's user is sleeping.

In another embodiment, a device's location (or a change in a device's location) may provide an indication of a wake status of the device's user. Electronic devices may be capable of determining their location with a high degree of precision (e.g., using global positioning satellite data or triangulation methods). As noted above, it is common for a device's user to charge the device's battery while the user sleeps. It is also common for the charging operation to take place with the device positioned in approximately the same location each time the user sleeps. For example, a user may utilize a charger placed on a nightstand to charge the device's battery each night. Accordingly, the comparison of a device's location with a known typical location of the device when the user sleeps may provide an indication of the user's wake status. It will be understood that the correlation of device location and a wake status of the device's user may need to be learned over time. That is, device location alone may initially be a poor indicator of the user's wake status, but as the device learns, over the course of time, that its location is consistent during the time periods that a user is determined to be asleep (e.g., based on other parameters), device location may become a good indicator of the user's wake status. In another embodiment, device location (even a location that does not correspond to a typical location during a time the user is sleeping) may be combined with other device parameters to provide a useful indication of wake status. For example, when a user is travelling, the device location will not correspond to a typical device location during a period of sleep, but, a stationary location at a typical time the user is sleeping or a stationary location along with an indication that the device is connected to a battery charger may provide a strong indication that the user is sleeping. Conversely, a change in location of a device might provide a strong indication that a user is awake. For example, a rapid change in location that indicates the user is travelling in a vehicle may provide an indication that the user is awake.

In another embodiment, the motion of a device may provide an indication of the user's wake status. Electronic devices may include motion sensors (such as gyroscopes, accelerometers, etc.) that provide an indication of a change in position or orientation of a device. A change in the position or orientation of a device (such as when the device is picked up or removed from a pocket) may provide an indication that the device's user is awake. Moreover, known motion patterns might also provide a good indication of the user's wake status. For example, a repetitive motion pattern may be recognized as indicative of a user carrying the device while walking, which may indicate that the user is awake,

In still another embodiment, an ambient light measurement may provide an indication of a user's wake status. Electronic devices may include a sensor to measure ambient light conditions. Because low ambient light conditions may be associated with a period during which a user is sleeping, low ambient light measurements for a certain duration may provide an indication that the user s asleep.

In yet another embodiment, the usage of a device may provide an indication of the user's wake status. For example, a user action to transition the device from a standby mode to an active mode, a touch gesture performed on a touch screen of the device, or the initiation of an application (especially an application for which an established pattern of use upon a wake status transition exists) may all indicate that the user is awake. While several wake status parameters have been described, it will be understood that a combination of two or more of the above techniques may also be used to determine a device user's wake status. Further, additional wake status parameters may be defined or may be automatically learned by the device based on the device user's particular wake status patterns.

Based on the evaluation of the wake status parameters, a wake status score may be determined for each evaluated parameter (block 110). In one embodiment, a wake status score for each parameter may be based on a confidence value associated with a wake status estimate (e.g., “awake” or “asleep”) for the parameter. In such an embodiment, a confidence value associated with a wake status estimate may indicate the likelihood that the wake status estimate is correct. Thus, a wake status score for a particular parameter may indicate the probability that the parameter's value is indicative of a particular wake status. By way of example, a motion measurement that indicates a device is being carried by a user that is walking may, by itself, be a strong indicator that the device's user is awake and may therefore lead to a high wake status score for an “awake” wake status estimate. In contrast, a low ambient light measurement that, in addition to providing an indication that a user is sleeping, might be associated with the simple placement of the device in a drawer or pocket may, by itself, be a weak indicator that the device's user is asleep and may therefore lead to a low wake status score for an “asleep” wake status estimate. The wake status score for a particular parameter might also be based on known wake status patterns. For example, the connection of a device to a battery charger may be a strong indicator that the device's user is asleep at 11:00 pm while the same action may be a weaker indicator that the device's user is asleep at 3:00 pm. Similarly, a user action to transition a device from a standby mode to an active mode may be a strong indicator that the user is awake at 8:00 am but a poor indicator that the user s awake at 3:00 am (e.g., because the user may perform such an action simply to view a time on the device). The wake status score for a particular parameter may also vary based on the user of the device. For example, a location measurement may be a stronger indicator of wake status for a user that consistently places a device in the same location during a sleeping period than for a user that places a device in different locations during a sleeping period. Consequently, the wake status scores associated with individual wake status parameters may be “tuned” to a particular user based on the user's pattern of usage of the device.

Using the individual wake status scores for the individual wake status parameters, a combined wake status score may be generated (block 115). In one embodiment, the combined wake status score may be based on a sum or product of the wake status scores associated with the individual wake status parameters. In one embodiment, a sign of a wake status score for a particular individual wake status parameter may be determined based on the wake status estimate. For example, a high confidence value wake status estimate of “asleep” may contribute to a summation as a large negative number whereas a high confidence value wake status estimate of “awake” may contribute to the summation as a large positive number. In another embodiment, the combined wake status score may be calculated based on an average of the wake status scores for the individual wake status parameters. In such an embodiment, the individual wake status scores may be calculated using a scale having a neutral value with values that diverge from the neutral value in one direction representing increased confidence in a wake status estimate of “awake” and values that diverge from the neutral value in the other direction representing increased confidence in a wake status estimate of “asleep.” It will be understood that additional algorithms may be employed to combine the individual wake status scores into a combined score that is representative of the wake status of a user of the device (e.g., the individual parameter probability values may be multiplied together or theft weighted sum or weighted products may be used).

The combined wake status score may be compared to a threshold score to determine the wake status of a user of a device (block 125). If the combined wake status score exceeds a threshold value (the “Yes” prong of block 125), it may be determined that the user's wake status is “awake” (block 130). If, however, the combined wake status score is lower than the threshold value (the “No” prong of block 125), it may be determined that the user's wake status is “asleep” (block 135). In one embodiment, the threshold score may have an associated “dead band” such that the determined wake status does not toggle between values when the combined wake status score is close to the threshold value. In such an embodiment, when a combined wake status score exceeds the threshold value, the wake status may be determined to be “awake” until the wake status score falls below the threshold value less the dead band value. Although the determination of a device user's wake status has been described in terms of a combined wake status score that exceeds a certain threshold representing a wake status of “awake” it will be understood that the combined wake status score may be structured in such a way that a score that exceeds a certain threshold represents a wake status of “asleep” or that other means of combining values from individual wake status parameters to determine the user's wake status may be employed.

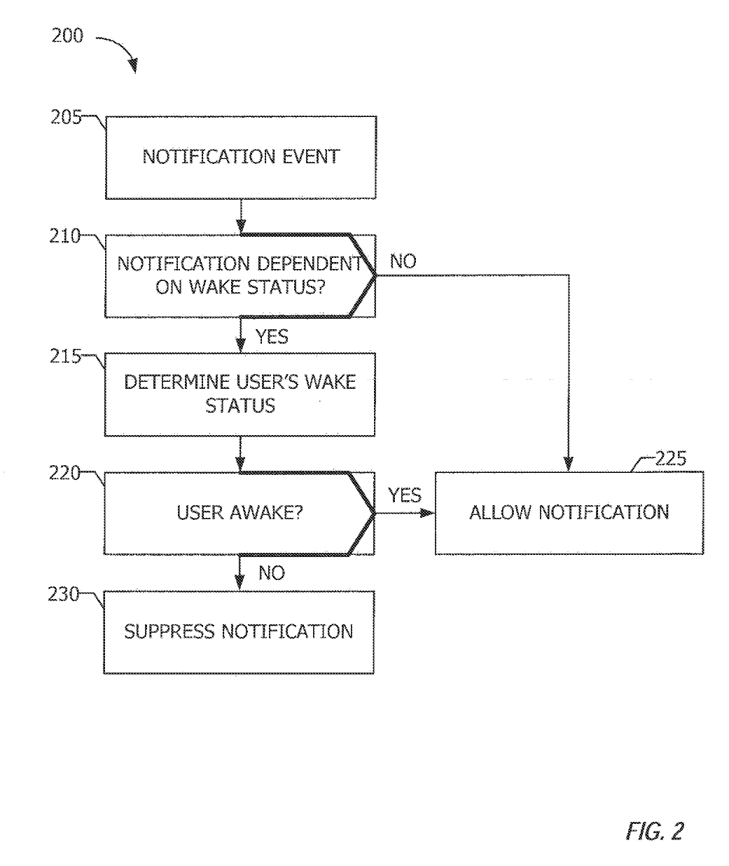

Referring to FIG. 2, alert suppression operation 200 may utilize a user's wake status to determine whether notifications for received events should be provided to a user. Initially, a notification event may occur at an electronic device (block 205). A notification event may be a communication that is received by the device (such as an electronic mail message, phone call, text message, etc.) or may be generated by the device itself (such as a reminder, alarm, etc.) that under normal operating conditions causes the device to notify the user. A device may typically provide a notification of the event by generating a sound, vibrating, etc. In accordance with operation 200, however, prior to notifying a user of the event, it may be determined if notification of the event is dependent upon a wake status of the user (block 210). As described in greater detail below, a user may wish to suppress notifications during a particular wake status. For example, the user may not wish to receive a notification for events that occur when the user's wake status is “asleep.” However, the user may define certain exceptions to the suppression of notifications. For example, a user may define certain individuals or groups of individuals for which the user wishes to receive a notification of a received communication regardless of the user's wake status. Accordingly, when an event occurs, it may be determined if the user has established any criteria for the suppression of notifications based on wake status and, if so, whether the event is of a type for which an exception to the notification suppression has been created.

If notification of the event is dependent upon the user's wake status (the “Yes” prong of block 210), the user's wake status may be determined (block 215). The user's wake status may be determined as described above with respect to operation 100. That is, wake status parameters of the device may be evaluated to automatically determine the user's wake status, in one embodiment, wake status determination operation 100 may be performed on a regular basis and the user's wake status saved as a device parameter. In such an embodiment, the determination of the user's wake status may simply involve retrieving the value of the wake status parameter. If it is determined that the event is not dependent upon the user's wake status (e.g., because no wake status-dependent notification suppression criteria have been established or because the event is subject to a suppression exception) or that the user is awake (the “No” and “Yes” prongs of blocks 210 and 220 respectively), a notification may be generated (block 225). That is, the device may generate a predefined ring tone, vibrate, display the event on a device display, etc. If, however, it is determined that the user s not awake (the “No” prong of block 220), a notification of the event may be suppressed. In one embodiment, the event (or a record of the event) may be maintained and the notification delivered when the wake status changes. For example, a user may be notified of a received e ail when the determined wake status changes.

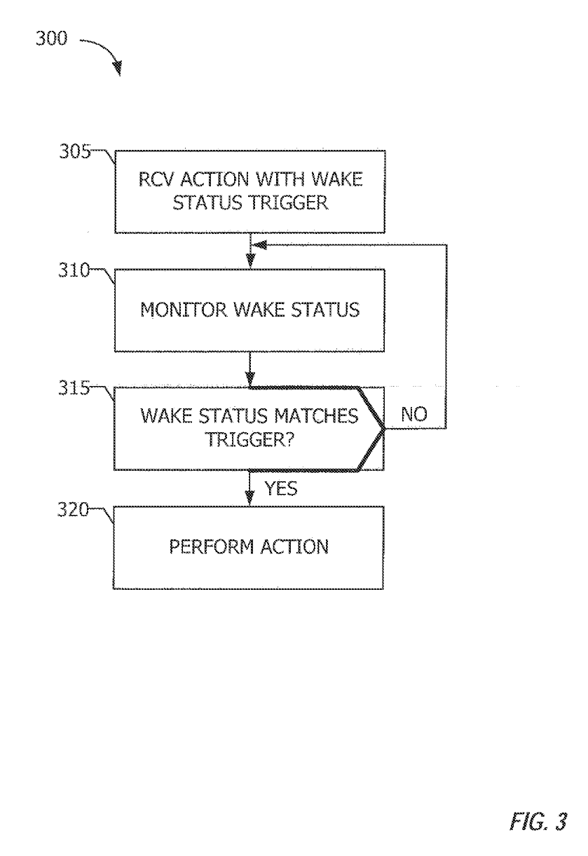

Referring to FIG. 3, wake status-triggered action operation 300 may begin with the receipt of an action configured according to a particular wake status (block 305). In one embodiment, the wake status-triggered action may be configured by a user of the device to occur based on a particular wake status state on a particular date. For example, a device user may create a reminder with an associated notification action that is triggered when a wake status is identified as “awake” on a particular day. In another embodiment, an action may be configured to occur at a particular wake status transition on a certain day. In such an embodiment, the device may maintain a most recent wake status value (e.g., the result of a most recent prior application of operation 100) in addition to a current wake status value. When the current wake status value and the most recent prior wake status value differ, it may be determined that a wake status transition having a particular transition direction (i.e., “asleep” to “awake” or “awake” to “asleep”) has occurred and any actions having a trigger value associated with the transition may be identified. For example, a user may create a reminder with an associated notification action to display the reminder upon the occurrence of an “asleep” to “awake” transition on Thursday,

As noted above, wake status determination operation 100 may be performed regularly such that the wake status of a user is regularly updated. Therefore, the current wake status state may be regularly monitored (block 310). It may then be determined if the identified wake status (or wake status transition) matches the trigger condition for the received action (block 315). For example, it may be determined if the identified wake status matches the particular date and state of the trigger event associated with the received action. Alternatively, it may be determined if an identified wake status transition matches the particular date and direction of the trigger event associated with the received action. If the identified wake status does not match the trigger event associated with the received action (the “No” prong of block 315), the device may continue to monitor the wake status. If, however, the identified wake status does correspond to the trigger event associated with the received action (the “Yes” prong of block 315), the action may be performed by the device (block 320). By way of example, a user may set a reminder for a doctor's appointment having an action to display the reminder and generate a notification when the user's wake status is “awake” on the day of the appointment. Similarly, a user might set a reminder to take a prescription medication having an action to display the reminder and generate a notification when the device identifies an “awake” to “asleep” transition on a particular day. Accordingly, rather than configuring an action to be performed at a predefined time that approximates a wake status, the user can configure an action to occur when the device determines that the actual wake status has occurred.

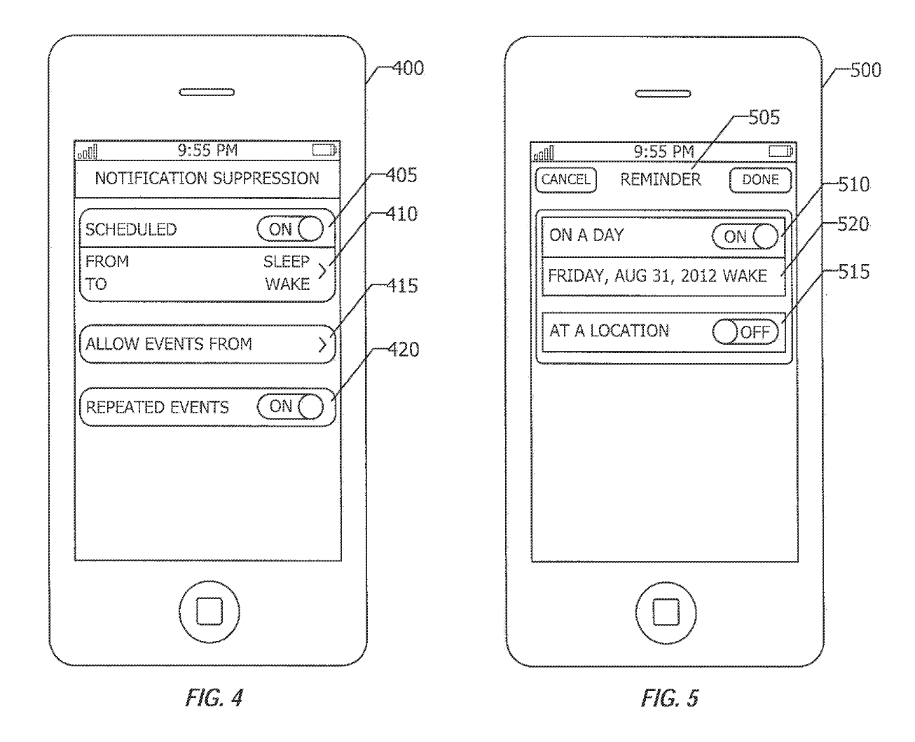

Referring to FIG. 4, an example notification suppression interface display on electronic device 400 illustrates the ability to suppress the notification of events based on wake status. Notification suppression interface 405 may allow a user to initiate notification suppression. When initiated, notification suppression may suppress notifications for events that occur during a specified period. The period during which notifications are to be suppressed may be defined using suppression period interface 410. Using suppression period interface 410, the user can define a notification suppression period that is dependent upon the user's wake status. For example, in the illustrated embodiment, the user has enabled notification suppression during the period that the user is sleeping (e.g., from the time of the “awake” to “asleep” wake status transition until the subsequent “asleep” to “awake” wake status transition). Accordingly, rather than using a fixed time period that approximates the period during which the user is sleeping, the device's determination of the user's actual wake status can be used to configure the suppression of notifications. In one embodiment, a user may define a fixed time-based start (end) time with the end (start) time based on wake status. For example, the notification suppression period may be defined from 10:00 pm until the user's wake status is “awake”. In another embodiment, because the device may regularly determine the wake status of the user, a wake status history may be maintained on the device such that a historical average wake status may be used to configure the suppression of notifications. For example, the user ay define a notification suppression period that extends from a historical average “awake” to “asleep” transition time to a historical average “asleep” to “awake” transition time, each of which may vary based on a day of the week, time of year, etc.

As described above with respect to FIG. 2, certain exceptions to the suppression of notifications may be defined by the user. Type exception interface 415 may be utilized to define certain types of events for which notifications should be generated even during the suppression period. For example, type exception interface 415 may allow a user to define certain individuals or certain groups of individuals for which events (e.g., telephone calls, email messages, social network messages, text messages, etc.) should result in a notification regardless of whether the notification suppression period is in effect. Therefore, notifications may be generated even during the notification suppression period for certain types of events that the user determines to be important. Similarly, repeated events interface 420, may allow a user to specify that a second (or third, fourth, etc.) event associated with a communication from the same person within a certain time period should result in a notification. Therefore, while a notification associated with a first event may be suppressed, a subsequent event based on a communication from the same person may be determined to be of greater importance such that a notification is generated for the subsequent event.

Referring to FIG. 5, an example reminder interface of electronic device 500 illustrates the ability to define an action having a wake status trigger. After a user defines reminder 505, a trigger event that may result in the generation of a notification and the display of the reminder may be established. The trigger event may be associated with a particular day (using date-based trigger interface 510) or a particular location (using location-based trigger interface 515). After selecting date-based trigger interface 510, the user may specify a particular date on which the reminder should be triggered (e.g., by selecting date specification interface 520). Rather than specifying a particular time at which reminder 505 should be triggered, a user may specify a wake status (or wake status transition) as a trigger event. For example, in the illustrated embodiment, the user has specified a wake status of “awake” on a particular date as a trigger event for reminder 505. Accordingly, reminder 505 may be presented on device 500 when the specified wake status occurs on the specified day. In another embodiment, a reminder having a wake status trigger event may be received from another device. For example, a reminder to “call your sister for her birthday” associated with an “asleep” to “awake” transition trigger event may be received as a communication from another device. Therefore, rather than specifying a fixed time that approximates a typical wake status transition, the device's determination of the user's actual wake status can be used to trigger an action (such as reminder 505). Although FIG. 5 illustrates an “awake” trigger event, it will be understood that a user might also specify an “asleep” trigger event. Moreover, it will be understood that actions other than reminder triggers may utilize wake status events. For example, a user may configure an alarm that begins at a low volume at a first time offset from a historical average wake status transition (e.g., one hour before a historical “asleep” to “awake” wake status transition time) and crescendos to a full volume at a second time offset from a historical average wake status transition. Therefore, actions may be configured to occur based on a device's determination of a user's actual wake status rather than a fixed approximation of the wake status.

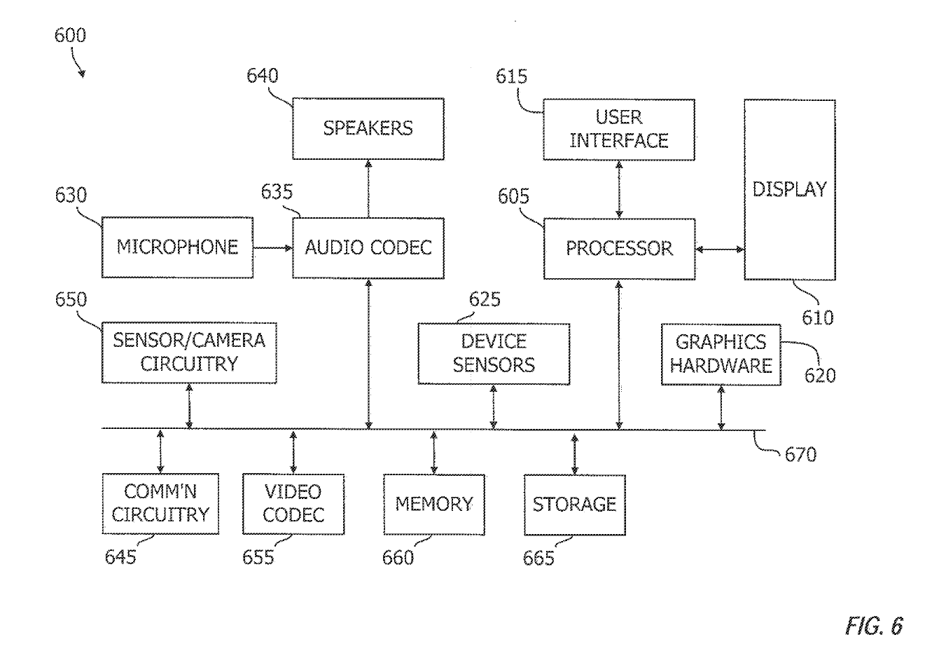

Referring to FIG. 6, a simplified functional block diagram of illustrative electronic device 600 is shown according to one embodiment. Electronic device 600 may include processor 605, display 610, user interface 615, graphics hardware 620, device sensors 625 (e.g., proximity sensor/ambient light sensor, accelerometer and/or gyroscope), microphone 630, audio codec(s) 635, speaker(s) 640, communications circuitry 645, digital image capture unit 650, video codec(s) 655, memory 660, storage 665, and communications bus 670. Electronic device 600 may be, for example, a personal digital assistant (PDA), personal music player, mobile telephone, notebook, laptop or tablet computer, desktop computer, or server computer. More particularly, the operations described above may be performed on a device that takes the form of device 600.

Processor 605 may execute instructions necessary to carry out or control the operation of many functions performed by device 600. Processor 605 may, for instance, drive display 610 and receive user input from user interface 615. User interface 615 can take a variety of forms, such as a button, keypad, dial, a click wheel, keyboard, display screen and/or a touch screen. Processor 605 may also, for example, be a system-on-chip such as those found in mobile devices and include a dedicated graphics processing unit (GPU). Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable graphics processing unit (GPU).

Sensor and camera circuitry 650 may capture still and video images that may be processed, at least in part, by video codec(s) 655 and/or processor 605 and/or graphics hardware 620, and/or a dedicated image processing unit incorporated within circuitry 650. Images so captured may be stored in memory 660 and/or storage 665. Memory 660 may include one or more different types of media used by processor 605 and graphics hardware 620 to perform device functions. For example, memory 660 may include memory cache, read-only memory (ROM), and/or random access memory (RAM). Storage 665 may store media (e.g., audio, image and video files), computer program instructions or software, preference information, device profile information, and any other suitable data. Storage 665 may include one or more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 660 and storage 665 may be used to tangibly retain computer program instructions or code organized into one or more modules and written in any desired computer programming language. When executed by, for example, processor 605 such computer program code may implement one or more of the methods described herein,

It is to be understood that the above description is intended to be illustrative, and not restrictive. The material has been presented to enable any person skilled in the art to make and use the inventive concepts described herein, and is provided in the context of particular embodiments, variations of which will be readily apparent to those skilled in the art (e.g., some of the disclosed embodiments may be used in combination with each other). Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein,”

1. A non-transitory program storage device, readable by a processor and comprising instructions stored thereon to cause the processor to:
identify an occurrence of an event on a device, the event having an associated notification;
automatically determine a wake status of a user of the device based on one or more measured device parameter values;
suppress the notification of the event if the wake status is a first value; and
allow the notification of the event if the wake status is a second value.

2. The non-transitory program storage device of claim 1, wherein the event comprises an incoming communication.

3. The non-transitory program storage device of claim 1, wherein the instructions to cause the processor to automatically determine a wake status of a user of the device based on one or more measured device parameter values comprise instructions to cause the processor to determine a combined wake status score.

4. The non-transitory program storage device of claim 3, wherein the instructions to cause the processor to automatically determine a wake status of a user of the device based on one or ore measured device parameter values comprise instructions to cause the processor to compare the combined wake status score to a wake status threshold.

5. The non-transitory program storage device of claim 1, wherein one of the one or more measured device parameter values comprises a measurement of ambient light conditions.

6. The non-transitory program storage device of claim 1, wherein one of the one or more measured device parameter values comprises an evaluation of the device's connection to a battery charger.

7. The non-transitory program storage device of claim 1, wherein one of the one or more measured device parameter values comprises a measurement of a location of the device.

8. The non-transitory program storage device of claim 7, wherein the instructions to cause the processor to automatically determine a wake status of a user of the device based on one or more measured device parameter values comprise instructions to cause the processor to compare the location of the device to a known typical location of the device associated with a particular wake status.

9. A non-transitory program storage device, readable by a processor and comprising instructions stored thereon to cause the processor to:
receive a request to perform an action on a device, the request having a trigger condition based on a wake status of a user of the device;
monitor the wake status of the user of the device, the wake status determined automatically based on an evaluation of one or more device parameters; and
perform the requested action when the wake status matches the trigger condition.

10. The non-transitory program storage device of claim 9, wherein the instructions to cause the processor to receive a request to perform an action comprise instructions to cause the processor o receive a request to display a reminder configured by the user of the device.

11. The non-transitory program storage device of claim 9, wherein the instructions to cause the processor to receive a request to perform an action comprise instructions to cause the processor to receive a request to display a reminder on the device as a communication from a second device.

12. The non-transitory program storage device of claim 9, wherein the trigger condition specifies a particular date and a particular direction of a transition in the wake status.

13. A device, comprising:
a memory;
a display; and
a processor operatively coupled to the memory and the display and configured to execute program code stored in the memory to:
identify an occurrence of an event on the device, the event having an associated notification;
determine whether the notification is dependent upon a wake status of a user of the device;
determine the wake status of the user when it is determined that the notification is dependent upon the wake status;
suppress the notification of the event if the wake status is a first value; and
allow the notification of the event if the wake status is a second value or the notification is not dependent upon the wake status.

14. The device of claim 13, wherein the event comprises an incoming text message.

15. The device of claim 13, wherein the program code to cause the processor to determine whether the notification is dependent upon a wake status of a user of the device comprises program code to cause the processor to determine whether the user has configured notification suppression settings for the event.

16. The device of claim 15, wherein the program code to cause the processor to determine whether the notification is dependent upon a wake status of a user of the device further comprises program code to cause the processor to determine whether the notification suppression settings comprise an exception for the event.

17. The device of claim 13, wherein the program code to cause the processor to determine the wake status of the user comprises program code to cause the processor to determine the wake status automatically based on one or more device parameter values.

18. The device of claim 17, wherein the program code to determine the wake status automatically based on one or more device parameter values comprises program code to compare the one or more device parameter values to typical values of the one or more device parameters for a particular wake status of the user.

19. The device of claim 18, further comprising program code to cause the processor to learn the typical values of the one or more device parameters for the particular wake status of the user.

20. The device of claim 17, wherein the program code to cause the processor to determine the wake status of the user further comprises program code to cause the processor to calculate a wake status score for each of the one or more device parameter values.

21. The device of claim 20, wherein the wake status score for each of the one or more device parameter values represents a probability of a particular wake status based on that device parameter.

22. The device of claim 20, wherein the program code to cause the processor to determine the wake status of the user further comprises program code to cause the processor to calculate a combined wake status score based on the wake status scores for each of the one or more device parameter values.
